(19) United States
(12) Patent Application Publication
(10) Pub. No.: US 2022/0351203 A1
(43) Pub. Date: Nov. 3, 2022

(54) PAYMENT SERVICE SYSTEM

(71) Applicant: HAREXINFOTECH INC., Seoul (KR)

(72) Inventor: Kyung Yang PARK, Seoul (KR)

(73) Assignee: HAREXINFOTECH INC., Seoul (KR)

(21) Appl. No.: 17/621,508

(22) PCT Filed: Jun. 19, 2020
(86) PCT No.: PCT/KR2020/007990

§ 371 Date: Dec. 21, 2021

(30) Foreign Application Priority Data
Jun. 21, 2019 (KR) 10-2019-0074362

(51) Int. Cl. G06Q 20/40; G06Q 20/32

(52) U.S. Cl. CPC G06Q 20/40; G06Q 20/3278; G06Q 20/3276

(57) ABSTRACT

The present disclosure relates to a payment service system. The payment service system may include a service offerer terminal configured to transmit payment target information through a wireless communication method; a user terminal configured to receive the payment target information and transmit a payment request; and a service provider server configured to transfer an approval result for the payment request by performing communication with a financial corporation server.

### TECHNICAL FIELD

The present disclosure relates to a payment service system.

### BACKGROUND ART

According to the related art, a payment service is provided through a process in which a seller terminal displays a QR code including payment target information, and a purchaser terminal recognizes such a QR code.

For example, a card reader terminal interconnected to a taximeter or an app meter of a wireless terminal such as a tablet, interconnected to the taximeter, displays a QR code, and a customer scans the QR code through his/her smart phone. Then, the customer is provided with a payment service for paying a taxi fare.

During nighttime driving, however, the customer may not recognize the QR code because lighting is not enough. In particular, when the customer is located in a rear seat of the taxi, it may be very inconvenient for the customer to recognize the QR code because the rear seat is considerably remote from the screen of the app meter installed on the dashboard of the taxi.

### DISCLOSURE

### Technical Problem

Various embodiments are directed to a payment service system which transmits payment-related information to a user terminal from a service offerer terminal through a wireless communication method (BLE, NFC or the like) in case of a user's payment request, and allows the user terminal to request payment through a service provider server.

### Technical Solution

In an embodiment, a payment service system may include: a service offerer terminal configured to transmit payment target information through a wireless communication method; a user terminal configured to receive the payment target information and transmit a payment request; and a service provider server configured to transfer an approval result for the payment request by performing communication with a financial corporation server.

### Advantageous Effects

In accordance with the present disclosure, a user terminal may recognize a TID (Transaction Identifier), generated according to a payment generation request of a service offerer terminal, through a wireless communication method (BLE, NFC or the like), and perform a payment request based on the corresponding TID, which makes it possible to solve the problems such as lighting and distance for QR code recognition in the related art.

In accordance with the present disclosure, a user terminal may receive payment target information (identification information and transaction target amount information of a service offerer terminal) from the service offerer terminal through a wireless communication method, and request payment for the payment target information, which makes it possible to solve the problem of QR code recognition in the related art.

In accordance with the present disclosure, the payment service system may provide a payment occupation request process for a payment request, thereby preventing duplicate charges for a plurality of user terminals.

In accordance with the present disclosure, the payment service system may allow a plurality of users to perform Dutch treat for a payment request, such that the plurality of users who share the service can smoothly perform Dutch treat.

In accordance with the present disclosure, the payment service system may allow a user to add a tip to payment target amount information and then make a payment request, thereby providing a payment process of increasing the payment amount according to the user's satisfaction.

### BRIEF DESCRIPTION OF DRAWINGS

FIG. 1 is a block diagram illustrating a payment service system in accordance with an embodiment of the present disclosure.

FIG. 2 is a sequence diagram illustrating a payment service process in accordance with the embodiment of the present disclosure, showing a process in which a service provider server generates a TID (Transaction Identifier), and payment target information is then transmitted/received between a service offerer terminal and a user terminal.

FIG. 3A is a sequence diagram illustrating a payment service process in accordance with an embodiment of the present disclosure, showing a payment process which is performed as a service offerer terminal transmits its ID and payment target information to a user terminal.

FIG. 3B is a sequence diagram illustrating a payment service process in accordance with an embodiment of the present disclosure, showing a payment process using a taximeter including a BLE (Bluetooth Low Energy) button.

FIG. 4 illustrates a process in which a taxi fare is displayed on a taximeter and a device at the same time, in accordance with an embodiment of the present disclosure.

FIG. 5 illustrates a payment target information request process in accordance with an embodiment of the present disclosure.

FIG. 6 illustrates a payment target information recognition and payment request process in accordance with an embodiment of the present disclosure.

FIG. 7 illustrates the contents of a QR code in accordance with an embodiment of the present disclosure.

FIG. 8 illustrates a payment completion screen of the user terminal in accordance with an embodiment of the present disclosure.

FIG. 9 illustrates a payment completion screen of the device in accordance with an embodiment of the present disclosure.

FIG. 10 illustrates a payment error screen of the device in accordance with an embodiment of the present disclosure.

FIG. 11 illustrates an approval cancellation process in accordance with an embodiment of the present disclosure.

FIG. 12 illustrates an approval cancellation process of the device in accordance with an embodiment of the present disclosure.

FIG. 13 illustrates an approval cancellation completion screen of the device in accordance with an embodiment of the present disclosure.

FIG. 14 illustrates an approval cancellation completion screen of the user terminal in accordance with an embodiment of the present disclosure.

### MODE FOR INVENTION

The aforementioned objects, other objects, advantages, and characteristics of the present disclosure and a method for achieving the objects, advantages and characteristics will be clearly described through the following embodiments with reference to the accompanying drawings.

However, the present disclosure is not limited to the following embodiments, but may be implemented in various shapes different from each other, and the following embodiments are only provided to easily deliver the objects, configurations and effects of the present disclosure to those skilled in the art to which the present disclosure pertains. Therefore, the scope of the present disclosure is defined by claims.

Terms used in this specification are used for describing embodiments, and not intended to limit the present disclosure. In the specification, the terms of a singular form may include plural forms unless specifically mentioned otherwise. The meaning of ‘comprise’ and ‘comprising’ used in the specification specifies a component, step, operation, and/or element but does not exclude the presence or addition of other components, steps, operations, and/or elements.

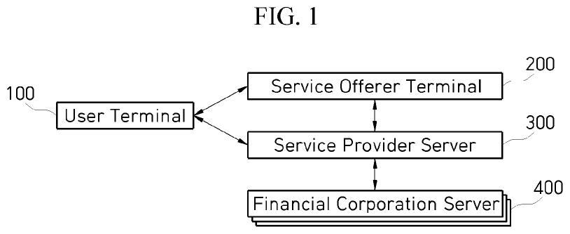

FIG. 1 is a block diagram illustrating a payment service system in accordance with an embodiment of the present disclosure.

The payment service system in accordance with the embodiment of the present disclosure includes a service offerer terminal 200, a user terminal 100, and a service provider server 300. The service offerer terminal 200 transmits payment target information through a wireless communication method. The user terminal 100 receives the payment target information, and transmits a payment request. The service provider server 300 transfers an approval result for the payment request by performing communication with a financial corporation server 400.

The service offerer terminal 200 generates a signal through BLE (Bluetooth Low Energy), NFC (Near Field Communication), sound wave or the like, and transmits the payment target information.

The service offerer terminal 200 generates the payment target information as a QR code, and displays the QR code while transmitting the QR code through a wireless communication method.

When receiving a payment generation request from the service offerer terminal 200, the service provider server 300 generates a TID (Transaction Identifier) and transmits the generated TID to the service offerer terminal 200, and the service offerer terminal 200 provides payment target information including the TID to the user terminal 100 through a wireless communication method.

The service provider server 300 transmits payment-related detail information to the user terminal 100 which has preoccupied an occupation request for the TID.

The service offerer terminal 200 provides the user terminal 100 with information including identification information of the service offerer terminal 200 and payment target amount information through a wireless communication method.

When receiving a payment completion confirmation from the service provider server 300 because the payment has been completed within a predetermined time, the service offerer terminal 200 stops transmitting the payment request. When not receiving a payment completion confirmation within the predetermined time, the service offerer terminal 200 automatically retransmits a payment request.

The service offerer terminal 200 maintains a one-to-one payment environment by adjusting the propagation distance of data to a preset distance in consideration of location information of a user.

The user terminal 100 provides an interface for deciding the final payment amount by adding a tip to the payment target information received from the service offerer terminal 200.

The user terminal 100 transmits a request for Dutch treat to a terminal of another user who shares the service.

In accordance with the embodiment of the present disclosure, as a payment request button is pressed, the service offerer terminal 200 transmits a payment request for a predetermined time (e.g. 15 seconds). The predetermined time is set to a time enough for the user to complete a payment completion operation.

At this time, the payment request may include the payment request information including the TID, received from the service provider server 300, or the payment target amount information provided from the service offerer terminal 200.

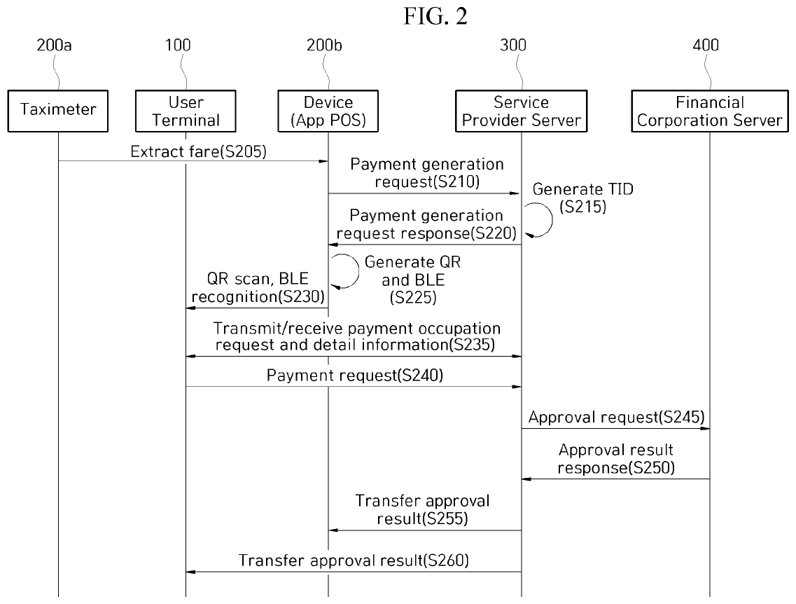

FIG. 2 is a sequence diagram illustrating a payment service process in accordance with an embodiment of the present disclosure, showing a process in which the service provider server 300 generates a TID and payment target information is then transmitted/received between the service offerer terminal and the user terminal.

A taximeter 200a calculates a fare based on driving information (time and distance), and transmits fare extraction information to a device 200b, in step S205.

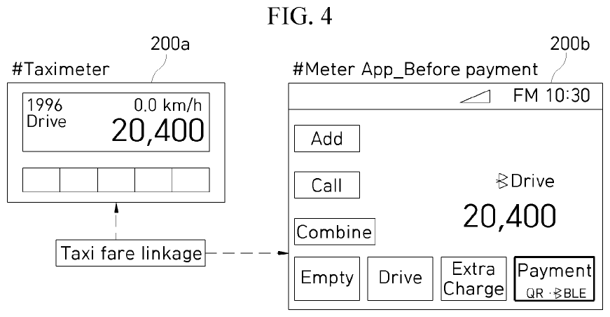

Referring to FIG. 4, the taximeter 200a and the device 200b share taxi fare information with each other, and the taxi fare information includes not only amount information, but also driving information (riding time, driving distance, and service provider information).

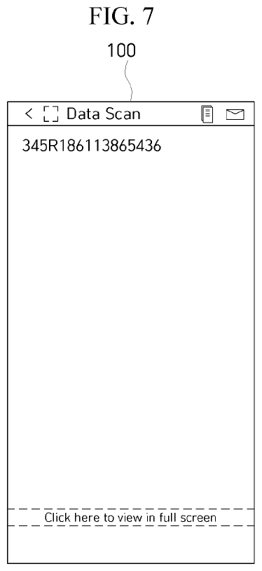

The device 200b has a payment button. As the payment button is pressed, the payment target information may be displayed and transmitted at the same time through QR and BLE, or selectively displayed/transmitted through QR or BLE. FIG. 7 illustrates the contents of a QR code in accordance with an embodiment of the present disclosure. TID represents a transaction identifier which is a transaction serial number generated by the service provider server in case of a payment request. Such a TID is designed in a transaction serial number format which is used for payment through a service provider application, and has 16-digit information of day-of-year (three digits)+R+year (two digits)+current time (five digits)+serial number (five digits). The current time is displayed as time information calculated in seconds.

The device 200b is a smart device interconnected to the taximeter 200a, and transmits a payment generation request to the service provider server 300, in step S210.

The service provider server 300 generates a TID according to the payment generation request in step S215, and transmits a payment generation request response to the device in step S220.

The device 200b generates a QR code or BLE signal in step S225.

The user terminal 100 scans the QR code or receives the BLE signal in step S230.

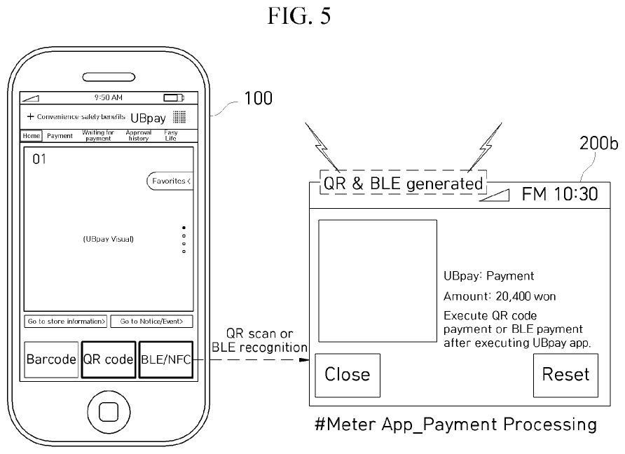

Referring to FIG. 5, a QR code or BLE signal is generated through the device 200b, and guidance words saying “Execute payment after executing the service provider application.” are displayed on the screen of the device 200b. At this time, the user terminal 100 automatically executes BLE payment when the Bluetooth function is turned on. When the Bluetooth function is turned off, the user executes the application and then presses a menu button to turn on the Bluetooth function. When a close button of the device 200b is pressed, the device 200b is returned to the screen before the payment, illustrated in FIG. 4. When a reset button is pressed, the generated payment request is canceled, and the fare is reset.

The user terminal 100 executes the service provider application, and then selects a desired recognition method to receive the payment target information, in step S230.

The user terminal 100 transmits a payment occupation request for the TID to the service provider server 300, and receives payment-related detail information from the service provider server 300 as the TID is completely occupied, in step S235.

The user terminal 100 selects a payment method and transmits a payment request to the service provider server 300 in step S240, and the service provider server 300 transmits an approval request to the financial corporation server 400 in step S245.

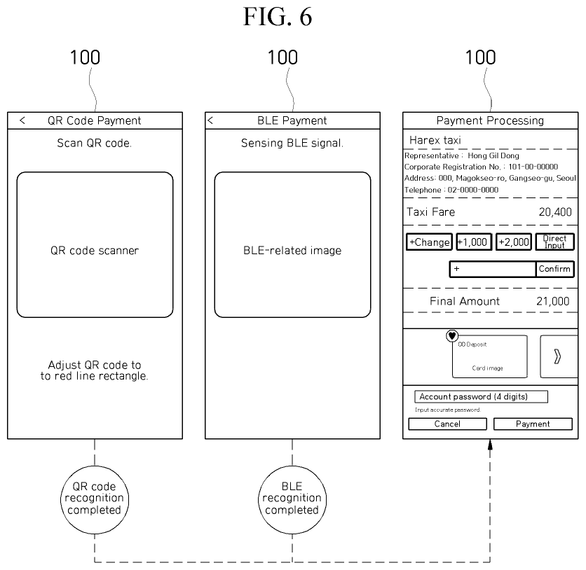

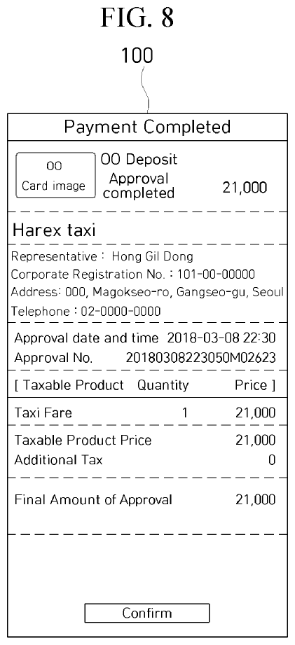

FIG. 6 illustrates a payment processing screen which is displayed as the user terminal 100 performs a QR code payment request or BLE payment request. At this time, the user sets the final payment amount by adding a tip to the payment target amount information through the screen of the user terminal 100. For example, when the user selects a change tip in case that the fare is 20,400 W (Korean Won), 600 W is added, and the total amount of 21,000 W is paid. The user may input amount information through a direct input tab of the user terminal 100, in order to input amount information to be added in person. Furthermore, the user may request a Dutch treat for a service fee through the user terminal, and execute the Dutch treat with another user who shares the same service. In this case, the total payment amount may be divided by the number of users who share the service (1/n) or proportionally divided through the terminal of a user who leads the payment (e.g. 5,000 W is requested for a fellow passenger A, and 7,000 W is requested for a fellow passenger B), in order to execute the Dutch treat. During the Dutch treat, one user may pay the total amount, and then send a Dutch treat request, for example, a Dutch treat through account transfer, to a fellow passenger with the payment completion information after the service is completely provided, for example, after the passengers get off the taxi. FIG. 8 illustrates a payment completion screen of the user terminal in accordance with an embodiment of the present disclosure. As described above, a subsequent request menu for Dutch treat may be added to the payment completion screen.

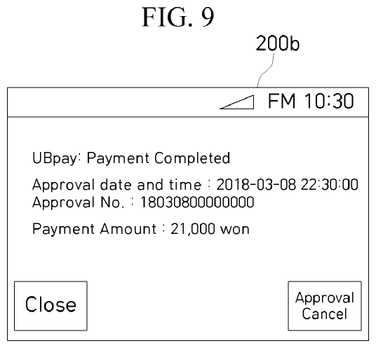

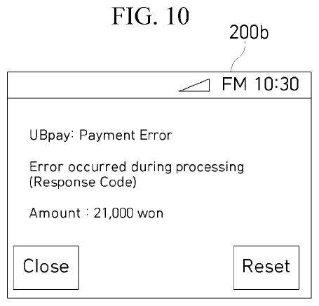

The service provider server 300 having received an approval result response to normal payment from the financial corporation server 400 transfers the approval result to the device 200b and the user terminal 100, in steps S255 and S260. FIG. 9 illustrates a payment completion screen of the device 200b in accordance with an embodiment of the present disclosure, and FIG. 10 illustrates a payment error screen of the device 200b in accordance with an embodiment of the present disclosure. When the user terminal fails to receive the approval result, the above-described payment request process is repeatedly performed until the approval result is received, or repeatedly performed until timeout.

When an error occurs during the payment processing, the device 200b displays, as a response code, a network error (network connection fail), no response (service response delay), or an approval error (max-out, payment method error, or other payment error).

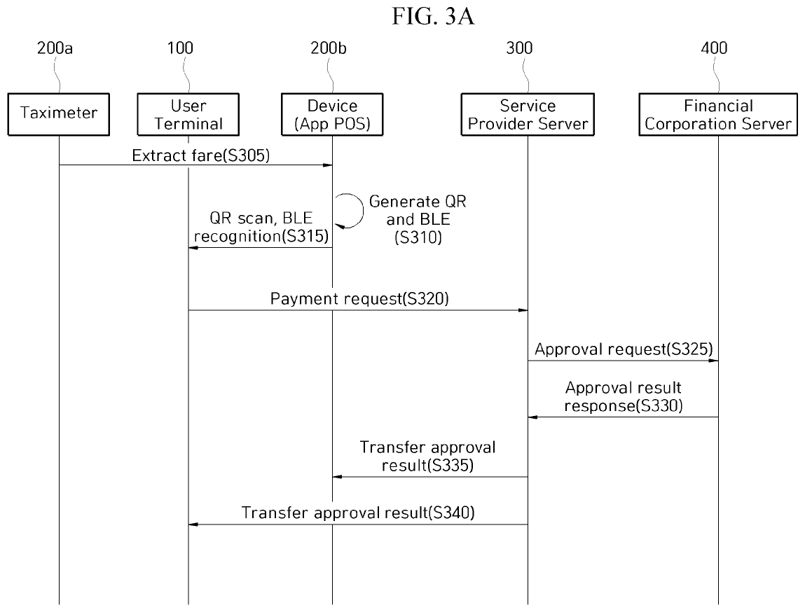

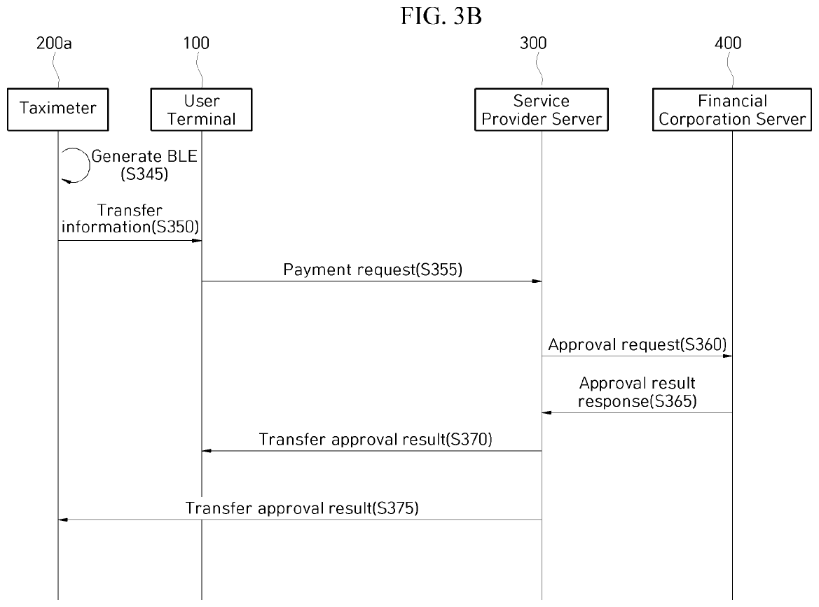

FIG. 3A is a sequence diagram illustrating a payment service process in accordance with an embodiment of the present disclosure, showing a payment process which is performed as the service offerer terminal transmits its ID and payment target information to the user terminal.

The taximeter 200a extracts fare information and transfer the extracted fare information to the device 200b in step S305, and the device 200b generates a QR code and BLE signal including the ID information of the device 200b and payment target amount information in step S310.

The user terminal 100 receives the ID information of the device 200b and the payment target amount information by recognizing the QR code from the device 200b or receiving the BLE signal from the device 200b, in step S315. Then, the user terminal 100 transmits a payment request for the payment target amount information to the service provider server 300 in step S320.

The service provider server 300 transmits an approval request to the financial corporation server 400 in step S325. When receiving an approval result response to normal approval from the financial corporation server 400 in step S330, the service provider server 300 transmits the approval result to the device 200b and the user terminal 100 in steps S335 and S340.

FIG. 3B is a sequence diagram illustrating a payment service process in accordance with an embodiment of the present disclosure, showing a payment process using a taximeter including a BLE button.

In the present embodiment, the taximeter 200a additionally includes a BLE button. As the BLE button is pressed, the taximeter 200a generates, as a BLE signal, information including the device ID information of the taximeter 200a and payment target amount information in step S345.

The user terminal 100 receives the information through the BLE signal in step S350, and transmits a payment request to the service provider server 300 in step S355.

The service provider server 300 transmits an approval request to the financial corporation server 400 in step S360. When receiving an approval result response to normal approval from the financial corporation server 400 in step S365, the service provider server 300 transmits the approval result to the taximeter 200a and the user terminal 100 in steps S370 and S375.

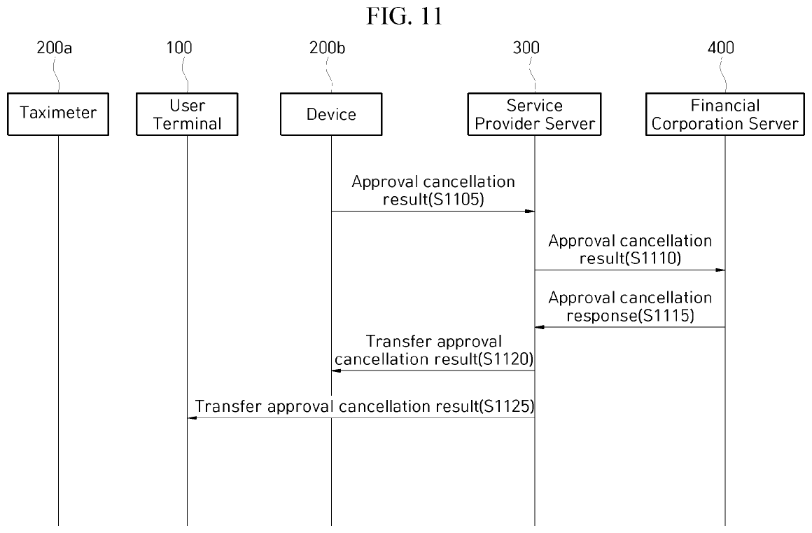

FIG. 11 illustrates an approval cancellation process in accordance with an embodiment of the present disclosure.

The device 200b transmits an approval cancellation request to the service provider server 300 in step S1105, and the service provider server 300 transfers the approval cancellation request to the financial corporation server 400 in step S1110.

When receiving an approval cancellation response from the financial corporation server 400 in step S1115, the service provider server 300 transfers an approval cancellation result to the device 200b and the user terminal 100, in steps S1120 and S1125.

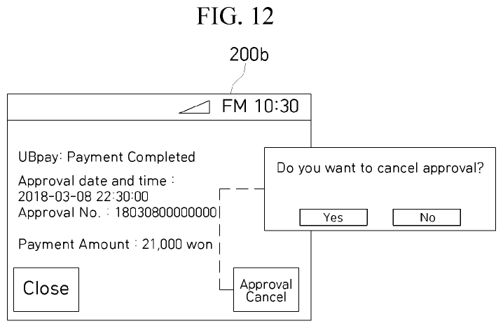

FIG. 12 illustrates an approval cancellation process of the device in accordance with an embodiment of the present disclosure.

When an approval cancellation button is pressed on the device, an approval cancellation selection window is displayed, such that a background screen button is not clicked.

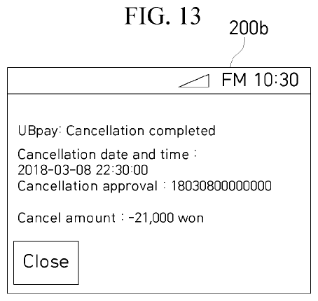

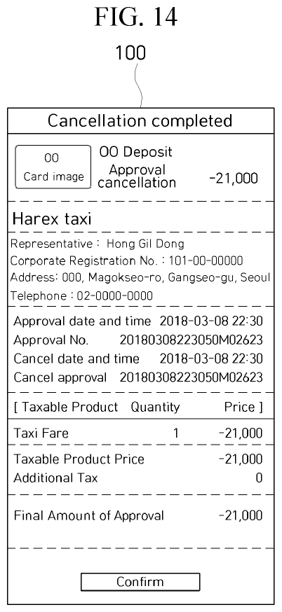

FIG. 13 illustrates an approval cancellation completion screen of the device in accordance with an embodiment of the present disclosure, and FIG. 14 illustrates an approval cancellation completion screen of the user terminal in accordance with an embodiment of the present disclosure.

The payment service method in accordance with the embodiment of the present disclosure may be implemented in a computer system or recorded into a recording medium. The computer system may include one or more processors, a memory, a user input device, a data communication bus, a user output device, and a storage. The above-described components perform data communication through a data communication bus.

The computer system may further include a network interface coupled to a network. The processor may be a CPU (Central Processing Unit) or a semiconductor device configured to process a command stored in the memory and/or storage.

The memory and the storage may include various types of volatile or nonvolatile storage media. Examples of the memory may include a ROM and RAM.

Therefore, the payment service method in accordance with the embodiment of the present disclosure may be implemented as a method which is executable in the computer. When the payment service method in accordance with the embodiment of the present disclosure is executed in a computer device, computer readable commands may perform the payment service method in accordance with the present disclosure.

The payment service method in accordance with the present disclosure may be implemented as computer readable codes in a computer readable recording medium. Examples of the computer readable recording medium include all types of recording media that store data which can be read by a computer system. Specific examples of the computer readable recording medium may include a ROM, RAM, magnetic tape, magnetic disk, flash memory, optical data storage device and the like. Furthermore, the computer readable recording medium may be stored and executed as codes which can be distributed in computer systems connected through a computer communication network, and read in a distributed manner.

Accordingly, the embodiments disclosed in the present disclosure are intended not to limit but to describe the technical spirit of the present disclosure, and the scope of the technical spirit of the present disclosure is not limited by the embodiments. The scope of the present disclosure shall be interpreted on the basis of the following claims, and it shall be interpreted that all the technical spirit within the scope equivalent thereto falls within the scope of the present disclosure.

1. A payment service system comprising:
a service offerer terminal configured to transmit payment target information through a wireless communication method;
a user terminal configured to receive the payment target information and transmit a payment request; and
a service provider server configured to transfer an approval result for the payment request by performing communication with a financial corporation server.

2. The payment service system of claim 1, wherein the service offerer terminal generates a signal through BLE (Bluetooth Low Energy), NFC (Near Field Communication) or sound wave, and transmits the payment target information.

3. The payment service system of claim 2, wherein the service offerer terminal generates the payment target information as a QR code, and displays the QR code while transmitting the QR code through the wireless communication method.

4. The payment service system of claim 1, wherein when receiving a payment generation request from the service offerer terminal, the service provider server generates a TID (Transaction Identifier) and transmits the generated TID to the service offerer terminal, and
the server provider terminal provides payment target information including the TID to the user terminal through a wireless communication method.

5. The payment service system of claim 4, wherein the service provider server transmits payment-related detail information to the user terminal which has preoccupied an occupation request for the TID.

6. The payment service system of claim 1, wherein the service offerer terminal provides the user terminal with information including payment target amount information and identification information of the service offerer terminal through a wireless communication method.

7. The payment service system of claim 1, wherein the service offerer terminal records the time at which the payment target information is transmitted, stops transmitting a payment request when receiving a payment completion confirmation from the service provider server within a predetermined time because the payment has been completed after the payment target information was transmitted, and automatically retransmits the payment request when not receiving a payment completion confirmation within the predetermined time.

8. The payment service system of claim 1, wherein the service offerer terminal maintains a one-to-one payment environment by adjusting the propagation distance of data to a preset distance in consideration of location information of a user.

9. The payment service system of claim 1, wherein the user terminal provides an interface for deciding the final payment amount by adding a tip to the payment target information received from the service offerer terminal.

10. The payment service system of claim 1, wherein the user terminal transmits a request for Dutch treat to a terminal of another user who shares the service.
